(19) United States
(12) Patent Application Publication
(10) Pub. No.: US 2015/0073694 A1
(43) Pub. Date: Mar. 12, 2015

(54) METHOD AND DEVICE FOR OEPRATING A VEHICLE

(71) Applicant: Stefan Nordbruch, Kornwestheim (DE)

(72) Inventor: Stefan Nordbruch, Kornwestheim (DE)

(21) Appl. No.: 14/370,949

(22) PCT Filed: Nov. 13, 2012
(86) PCT No.: PCT/EP2012/072465

§ 371 Date: Jul. 7, 2014

(30) Foreign Application Priority Data
Jan. 9, 2012 (DE) 10 2012 200 192.1

(51) Int. Cl. G01C 21/34

(52) U.S. Cl. CPC G01C 21/34
USPC 701/400

(57) ABSTRACT

In a method for operating a vehicle, based on a current travel route of the vehicle, a database which includes reference route data assigned to the current travel route is queried as to whether a change in a feature of the current travel route has occurred, and a response of the database that corresponds to the query is made available.

### BACKGROUND OF THE INVENTION

1. Field of the Invention

The present invention relates to a method, a computer program and a device for operating a vehicle.

2. Description of the Related Art

Changed traffic situations such as changes in the right-of-way rule, changes in the allowed speeds, a new signal system or, for example, a new zebra crossing, may be the cause of accidents or traffic violations.

### BRIEF SUMMARY OF THE INVENTION

The object on which the invention is based is to indicate a method for operating a vehicle that ensures a safe vehicle operation.

The objective on which the present invention is based may also be seen in providing a corresponding device for operating a vehicle, a corresponding system for operating a vehicle, and a corresponding computer program.

According to one aspect, a method for operating a vehicle is provided. Based on a current travel route of the vehicle, a database which contains reference route data assigned to the current travel route is queried. This therefore means in particular that the reference route data are stored in the database. Specifically, it is queried whether a change with regard to a feature of the current travel route has occurred in the current travel route, whereupon a response of the database corresponding to the query is made available.

According to another aspect, a device for operating a vehicle is provided. The device includes a database interrogator, which is designed to query, based on a current travel route of the vehicle, a database which contains reference route data assigned to the current travel route of the vehicle, as to whether changes have occurred in the current travel route with regard to a particular feature of the current travel route. Furthermore, the device includes a furnishing device for furnishing a response of the database corresponding to the query.

According to another aspect, a system for operating a vehicle is provided. The system includes the device for operating a vehicle, and a database in which reference route data are stored that are assigned to travel routes.

According to a still further aspect, a computer program is provided, which includes program code for executing the method for operating a vehicle when the computer program is run on a computer.

That is to say, the present invention in particular encompasses the idea that the current travel route is checked in order to ascertain whether it includes a change in a feature of the current travel route. The response then in particular includes the information whether or not the current travel route includes a corresponding change. Because this response is provided, it is advantageously possible, for instance, to take appropriate steps to prepare for the change in the current travel route. This advantageously enables safe driving.

One feature within the meaning of the present invention in particular includes a physical feature, which may also be referred to as a physical object, of the travel route. One such physical feature or physical object could be a signal system, for example, such as a traffic light, a zebra crossing, a demarcation post or changed road routing. One feature within the meaning of the present invention preferably may be a traffic rule, such as a rule concerning the right of way, or a rule pertaining to the speed. A physical object or feature could be a traffic sign, for instance. A feature, in particular, may be a characteristic of the road, such as a road width, road lane width, curve radii, and/or exits. A feature in particular may be a position and/or dimensions of physical objects of the road.

In the present invention it is therefore queried, for example, whether a change in a traffic rule has occurred in the current travel route. Specifically, it may be queried whether the traffic routing has been changed. In this context it may be provided in particular that it is stored in the reference route data whether, and if so, when individual features have been changed. This information will then be able to be made available, in particular. Preferably, a corresponding time for the change is assigned to the reference route data.

In one specific embodiment, the querying includes the transmission to the database of travel route data that correspond to the current travel route, and the response is formed by comparing the travel route data with the reference route data. The travel route data and the reference route data in particular include information about features, in particular physical features, of the current travel route.

This means in particular that the current travel route with its features and properties is transmitted to the database, and the travel route is then compared with the reference route and its reference features and reference properties. A deviation advantageously indicates a change in features and properties.

It may preferably be provided that the travel route data are composed with the aid of a navigation system. The navigation system preferably ascertains a current vehicle location and, in particular, has knowledge of a desired destination of a driver and thus is able to calculate a current travel route accordingly. A current travel route, for example, may be a route the driver has input into the navigation system. Preferably, it may be provided that the navigation system calculates a potential travel route on the basis of multiple vehicle positions ascertained consecutively and then uses it as current travel route for the query to the database. The potential travel route thus in particular is a travel route that the vehicle is going to use at a predefined probability. Preferably, it may be provided that variants of the potential travel route are ascertained. Such variants, for example, are travel routes that the vehicle is likely to take at a further predefined probability, which is smaller than the predefined probability of the potential travel route. It may be the case, in particular, that the potential travel route and/or the variants of the potential travel route are checked with regard to changes with the aid of the database query.

Preferably, it may be provided that the potential travel route is compared to a set of standard travel routes. Standard travel routes, for instance, may be travel routes regularly used by a driver, e.g., a daily travel route to work or to a shopping or recreation location or a place of residence. The found standard route is then checked especially with regard to changes, using the database query. In particular, it may be provided that a potential travel route is detected as a standard travel route in the comparison even if deviations exist between the two routes, especially if the deviations lie below a predefined deviation value. That is to say, an agreement between the standard travel route and the potential travel route need not necessarily be 100% in order to classify the potential travel route as a standard travel route. In particular, an agreement of 90%, especially 80%, preferably 70%, e.g., 60%, in particular 50%, may also be provided for the purposes of classification. In other words, this means in particular that the potential travel route is compared to a set of standard travel routes, and if a predefined agreement exists between the potential travel route and a standard travel route of the set of standard travel routes, the potential travel route will be classified as the standard travel route, which will then be used as the current travel route for the query to the database.

Travel route data within the meaning of the present invention in particular include feature data that correspond to the features. As a rule, features such as prescribed speeds, turn-offs and right-of-way rules are indicated on a digital map of the navigation system, so that, in particular, it is advantageously checked by the query to the database whether these features of the digital map are still up-to-date; if a change with respect to the reference route data has occurred, it is provided in particular that the corresponding response of the database is made available indicating whether or not the features of the digital map are still current.

In a further specific embodiment, it may be provided that the database includes an external database which is disposed externally from the vehicle, and/or an internal database which is situated inside the vehicle. A communication between the vehicle, especially the database interrogator, and the external database may be carried out using a wireless communications method, for example. Preferably, such a wireless communications method may include a WLAN communications method and/or a mobile telephony communications method. For example, a mobile communications method may be the Long Term Evolution (LTE) mobile radio communications method, for instance. A communication between the vehicle and the external database may preferably be carried out using the C2I communications method. “C” represents “car”, “2” represents “to”, and “I” means “infrastructure”. Such a communications method thus describes a communications method between a vehicle and a fixed infrastructure, such as a signal system or a building that is not a vehicle.

A communication between the database interrogator and the internal database, for example, may be carried out using a wireless communications method, especially WLAN or Bluetooth. In particular, a wire-bound communication may be provided between the database interrogator and the internal database.

It may be provided in the communication between the database interrogator and the external database that the database interrogator communicates directly with the external database. The communication between the database interrogator and the external database preferably takes place by means of a mobile telephone, which communicates with the database interrogator via Bluetooth or WLAN, for example.

Preferably, it may be provided that an internal database is updated at predefined intervals. For example, a driver may manually download corresponding updating data and then copy them into the internal database via a data carrier, for instance.

Providing an external database in particular has the advantage that it is usually more current and is able to be updated more easily. Providing an internal database has the particular advantage that it requires no external communication with an external database, so that the method functions especially also at locations without mobile phone coverage, such as tunnels or mountains. Providing both an internal and external database in particular has a redundancy advantage, so that in the event of a malfunction of one of the databases, for example, access is still possible to the other database.

According to one further specific embodiment, the database is queried at predefined intervals. The database may preferably be queried at the start of travel.

According to one further specific embodiment, the furnishing of the response constitutes the furnishing of a warning signal in the event that the current travel route includes a change. For example, the warning signal may be a haptic, optical or acoustic warning signal. Preferably, the warning signal may include the information pertaining to the specific type of change. Multiple warning signals may preferably be made available. The multiple warning signals may preferably have the same or a different form.

In another specific embodiment, the response of the database is provided a predefined distance before the changed physical feature is encountered. This advantageously ensures, for example, that a driver obtains knowledge of the change in a timely manner, so that the driver is still able to take suitable steps.

In another specific embodiment, it may be the case that the response is provided by means of a man-machine interface disposed inside the vehicle, and/or by means of a mobile telephone.

The present invention will be explained in greater detail in the following text with reference to preferred exemplary embodiments.

### BRIEF DESCRIPTION OF THE DRAWINGS

FIG. 1 shows a flow chart of a method for operating a vehicle.

FIG. 2 shows a flow chart of a further method for operating a vehicle.

FIG. 3 shows a device for operating a vehicle.

FIG. 4 shows a system for operating a vehicle.

### DETAILED DESCRIPTION OF THE INVENTION

In the following text, the same reference numerals are used for the same features.

FIG. 1 shows a flow chart of a method for operating a vehicle. According to a step 101, based on a current travel route of the vehicle, a database which contains reference route data assigned to the current travel route of the vehicle is queried as to whether a change in a feature of the current travel route has occurred in the current travel route. Therefore this means in particular that a corresponding query is transmitted to the database, which then transmits a corresponding reply. According to a step 103, a response of the database that corresponds to the query is made available.

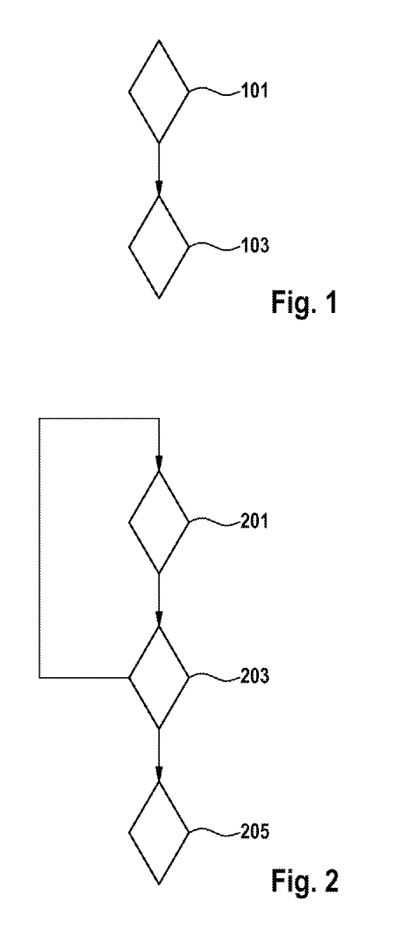

FIG. 2 shows a flow chart of a further method for operating a vehicle. In a step 201, travel route data corresponding to the current travel route are transmitted to the database. In a step 203, these travel route data are compared with reference route data. If a change is determined in this context, then a warning signal is made available in step 205 using a man-machine interface, so that a driver advantageously becomes aware of the change and is able to take suitable countermeasures. A vehicle operation becomes considerably safer as a result. The warning signal in particular may include information about the specific type of change.

If it is determined in step 203 that the reference route data match the travel route data, i.e., in particular that no change has occurred in the current travel route, the method is restarted in step 201. For example, it is possible to provide a pause prior to a new query.

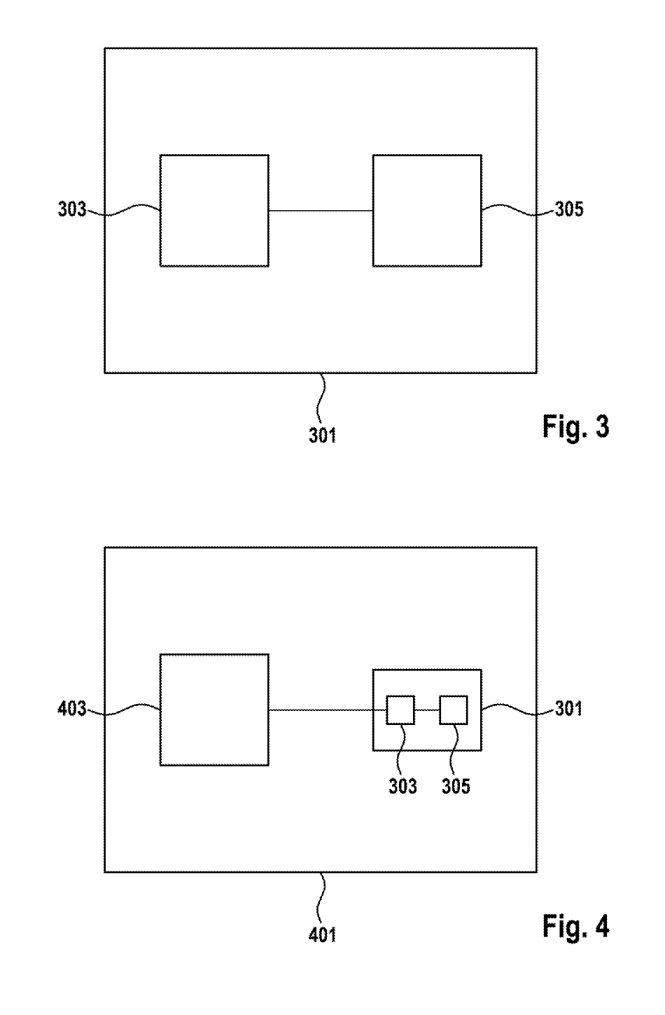

FIG. 3 shows a device 301 for operating a vehicle. Device 301 includes a database interrogator 303, which is designed to query a database which includes reference route data that is assigned to the current travel route of the vehicle, as to whether the current travel route includes changes with regard to a particular feature of the current travel route. The corresponding response of the database is made available by means of a furnishing device 305.

In one specific embodiment (not shown), furnishing device 305 may include a man-machine interface. Such a man-machine interface may encompass a screen, for instance. Furnishing device 305 may include a mobile telephone, in particular.

FIG. 4 shows a system 401 for operating a vehicle. System 401 includes device 301 according to FIG. 3, and a database 403, which includes reference route data assigned to travel routes.

1-12. (canceled)

13. A method for assisting navigation of a vehicle, comprising:
determining a current travel route of the vehicle;
querying a database, which includes reference route data assigned to the current travel route of the vehicle, whether a change in a feature of the current travel route of the vehicle has occurred; and
outputting, by the database, a response to the query.

14. The method as recited in claim 13, wherein the querying includes transmitting travel route data corresponding to the current travel route of the vehicle to the database, and wherein the response is formed by comparing the transmitted travel route data with the reference route data of the database.

15. The method as recited in claim 14, wherein the database includes an external database which is disposed externally from the vehicle.

16. The method as recited in claim 14, wherein the querying of the database is repeated at predefined time intervals.

17. The method as recited in claim 14, wherein the response to the query includes providing of a warning signal if a change in a feature of the current travel route of the vehicle has occurred.

18. The method as recited in claim 17, wherein the response of the database is outputted when the vehicle is located at a predefined distance preceding the location of the changed feature of the current travel route.

19. The method as recited in claim 18, wherein the response is outputted via at least one of (i) a man-machine interface disposed inside the vehicle, and (ii) a mobile telephone.

20. The method as recited in claim 17, wherein a potential travel route is formed based on consecutive multiple locations of the vehicle ascertained over time, and wherein the potential travel route is used as the current travel route for the querying of the database.

21. The method as recited in claim 20, wherein the potential travel route is compared to multiple standard travel routes, and wherein the potential travel route is used as the current travel route for the querying of the database only if a predefined agreement exists between the potential travel route and one of the multiple standard travel routes.

22. A system for assisting navigation of a vehicle, comprising:
a database containing reference route data;
a database interrogator configured to (i) ascertain a current travel route of the vehicle, and (ii) query the database whether a change in a feature of the current travel route of the vehicle has occurred; and
a furnishing device which furnishes a response of the database to the query;
wherein a potential travel route is formed based on consecutive multiple locations of the vehicle ascertained over time, and the potential travel route is used as the current travel route for the querying of the database, and wherein the querying includes transmitting travel route data corresponding to the current travel route of the vehicle to the database, and wherein the response is formed by comparing the transmitted travel route data with the reference route data of the database.

23. A non-transitory, computer-readable data storage medium storing a computer program having program codes which, when executed on a computer, performs a method for operating a vehicle, the method comprising:
determining a current travel route of the vehicle;
querying a database, which includes reference route data assigned to the current travel route of the vehicle, whether a change in a feature of the current travel route of the vehicle has occurred; and
outputting, by the database, a response to the query;
wherein a potential travel route is formed based on consecutive multiple locations of the vehicle ascertained over time, and the potential travel route is used as the current travel route for the querying of the database, and wherein the querying includes transmitting travel route data corresponding to the current travel route of the vehicle to the database, and wherein the response is formed by comparing the transmitted travel route data with the reference route data of the database.
